(19) United States
(12) Patent Application Publication
(10) Pub. No.: US 2008/0014127 A1
(43) Pub. Date: Jan. 17, 2008

(54) Pilot test method for multitubular reactor

(75) Inventors: Yasushi Ogawa, Mie (JP); Shuhei Yada, Mie (JP); Yoshiro Suzuki, Mie (JP); Kenji Takasaki, Mie (JP); Kimikatsu Jinno, Mie (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI CHEMICAL CORPORATION, Minato-ku, Tokyo (JP)

(21) Appl. No.: 11/596,293

(22) PCT Filed: Oct. 25, 2004
(86) PCT No.: PCT/JP04/16178

§ 371 Date: Mar. 23, 2007

(30) Foreign Application Priority Data
May 13, 2004 (JP) 2004-143307

(51) Int. Cl. B01J 19/00

(52) U.S. Cl. 422/130; 436/37

(57) ABSTRACT

An object of the present invention is to provide a pilot test method for suitably setting the reaction conditions for a gas-phase catalytic reaction using a multi-tube reactor, and an apparatus thereof. The present invention is a pilot test method in which a plurality of reaction tubes which are substantially the same as a reaction tube of a multi-tube rector and composed of at least one reaction tube having a means provided for measuring the temperature of a catalyst layer, and remaining reaction tubes having no temperature measuring means, are immersed in a heat medium, a given raw material gas is allowed to flow through the reaction tubes to react, the temperature of the catalyst layer is measured at this stage, the reaction result of the reaction product gas to be discharged is analyzed in the reaction tube having no temperature measuring means, and the reaction conditions of the multi-tube reactor are set so that the reaction at the temperature of the catalyst layer measured generates the reaction result analyzed.

### TECHNICAL FIELD

The present invention relates to a pilot test method for setting the reaction conditions of a gas-phase catalytic reaction using a multi-tube reactor constituted of reaction tubes having inside a layer of a solid particle-form catalyst, more particularly, to a pilot test method in which a plurality of reaction tubes which are substantially the same as a reaction tube of a multi-tube rector and composed of at least one reaction tube having a means provided for measuring the temperature of a catalyst layer, and remaining reaction tubes having no temperature measuring means, are immersed in a heat medium, a given raw material gas is allowed to flow through the reaction tubes, the temperature of the catalyst layer is measured at this stage, the reaction result of the reaction product gas to be discharged is analyzed in the reaction tube having no temperature measuring means, and the reaction conditions of the multi-tube reactor are set so that the reaction at the temperature of the catalyst layer measured generates the reaction result analyzed.

### BACKGROUND ART

In reactions of an industrial scale, particularly, in a gas-phase catalytic reaction using a non-uniform catalyst, matter derived from the heat transfer of a catalyst layer such as heat supplying and heat removal are often problematic. For example, in heat generation reactions such as an oxidation reaction and the like, because of an increase in the heat transfer surface area per unit mass of a catalyst due to a problem of heat removal, the reaction is often conducted using a multi-tube reactor constituted of a great number of reaction tubes containing an internally filled solid particle-form catalyst. In such a reactor, it is usual that the reaction volume is limited to the inside of a reaction tube filled with a catalyst, and a flowable heat conductive medium (heat medium) percolating for heating or cooling is present in a void between reaction tubes in a reactor shell accommodating the reaction tubes. The solid particle-form catalyst used here is generally a non-supported catalyst or a supported catalyst obtained by coating a carrier material with an active component. Such a multi-tube reactor filled with a solid particle-form catalyst is used in the chemical industry, for example, production of phthalic anhydride from o-xylene, and production of (meth)acrolein and/or (meth)acrylic acid from propylene, isobutylene.

With evaluation of any of these conditions of such a multi-tube reactor filled with a solid particle-form catalyst, the quality and conversion of the expected product is significantly influenced by temperature along the flow route (individual reaction tube) of a reaction component in the reactor. Usually, this temperature profile [temperature distribution along the vertical direction of individual reaction tube (axis line direction)] is measured by a thermocouple or resistance thermometer. For industrial use, these temperature measuring means are inserted as they are into a reaction tube in the case of fixing at certain place and measuring, and in the case of intending transfer along the vertical direction and confirmation of temperature distribution, these temperature measuring means are, usually, placed in the form of engagement in a protective tube inserted in a reaction tube.

However, since such a temperature measuring means occupies a certain volume in a reaction tube, this means, in general, there is a problem that it changes the pressure profile [pressure distribution along the vertical direction of the individual reaction tube (axis line direction)] and consequently changes differential pressure behavior of a reaction tube having a temperature measuring means provided. Further, since temperature measurement is usually performed in one or more reaction tubes typifying all reaction tubes, it is necessary that the reaction process in a reaction tube of which the temperature is measured is the same as the reaction process in a reaction tube having no temperature measuring means, however, this is not necessarily easy.

As that solving such problems, Patent Document 1 (JP-A-10-309457) suggests a multi-tube reactor which is composed of at least two identical type reaction tubes filled with a solid particle-form catalyst wherein at least one reaction tube has a temperature measuring means, and in which reaction tubes are designed so that both the ratio of the mass of a catalyst in each reaction tube to the free cross-sectional area thereof, and decrease in pressure (differential pressure) measured by an inert gas introduced along the tube axis direction in proportion to the free cross-sectional plane are identical over respective whole reaction tubes.

In the above-mentioned multi-tube reactor described in Patent Document 1, if filling is so conducted that the ratio of the mass of a solid particle-form catalyst to the free cross-sectional area and decrease in pressure in supplying a gas to a filling layer, namely, differential pressure are identical, temperature can be measured correctly even in a reaction tube having a temperature measuring means.

Patent Document 2 (JP-A-2003-1094) suggests a multi-tube reactor having a measuring apparatus (temperature measuring means or pressure measuring means) provided in at least one reaction tube in which substantially the same solid particle-form catalysts are filled in a reaction tube having a measuring apparatus and a reaction tube having no measuring apparatus, and setting is made so that the thicknesses of the catalyst layers and the differential pressures of the catalyst layers in supplying a gas are substantially the same in respective reaction tubes.

According to the above-mentioned suggestion of Patent Document 2, even if solid particle-form catalysts differing in particle size and shape are not used for adjustment of the differential pressure between a reaction tube having a measuring apparatus and a reaction tube having no measuring apparatus, adjustment can be made so that differential pressures in supplying a gas in respective reaction tubes are substantially the same, by using substantially the same solid particle-form catalyst, and changing the filling time of the solid particle-form catalyst so that the lengths of filling layers of solid particles in respective reaction tubes are substantially the same.

However, according to options of the present inventors, it is extremely difficult that the temperature profile and reaction result of a catalyst layer in a reaction tube having a temperature measuring means are the same as those of a reaction tube having no temperature measuring means even if they can be approximated to a certain degree according to the suggested methods.

### DISCLOSURE OF THE INVENTION

The present invention has been made in view of a condition that dissociation of measurement of a reaction tube for measuring and actual reaction condition cannot be decreased by conventional methods as described above and a further improvement is required, and an object thereof is to provide a pilot test method in which the measuring temperature of a reaction tube for measurement can correctly reflect the actual condition in a reaction tube, and a test apparatus for this method.

For obtaining the temperature profile in a reaction tube, and the reaction conversion and reaction yield in a reaction of producing acrolein and acrylic acid by gas-phase catalytic oxidation of propylene, the present inventors have performed the following procedure. Two stainless steel tubes having an internal diameter of 25.4 mm and a length of 3.5 m filled with a molybdenum-bismuth-based complex oxide catalyst in the form of solid particle usually used in this reaction were used as a reaction tube, and a thermocouple for 20 points measurement inserted in a protective tube having a diameter of 4 mm so that it can move along the tube axis direction (reaction tube a) was inserted in one of the two tubes, and a thermocouple of one point measurement mode having a diameter of 0.6 mm was fixed at a position about 70 cm from the surface of a catalyst layer in the other tube (reaction tube b), these were immersed in the same heat medium, and a raw material gas containing propylene was allowed to flow in the same amount through respective reaction tubes. Then, the measured temperature in the reaction tube b was higher by 4° C. than the maximum temperature in the reaction tube a, and the reaction conversion of propylene was 98.4% and the total yield of acrolein and acrylic acid was 92.2% in the reaction tube b, being higher by 0.3% in conversion and lower by 0.2% in total yield as compared with those in the reaction tube a.

Next, when operation was continued for 8 months while controlling the temperature of a heat medium so that the reaction conversion in the reaction tube a was kept at 98±0.3%, the temperature of a heat medium increased by 1.2° C. and the total yield during this was 91.9%.

Further when operation was continued in the same manner for 10 months so that the reaction conversion in the reaction tube b was kept at 98±0.3%, the initial yield was 92.5% and, 92.0% 10 months after, and the temperature of a heat medium increased by 0.8° C.

Thus, the maximum temperature of a catalyst layer in the reaction tube a into which a broad thermocouple had been inserted was lower than the temperature of a catalyst layer in the reaction tube b to which a narrow thermocouple had been fixed, and the reaction yield thereof was higher in contrast. From this, it is estimated that the maximum temperature of a catalyst layer in a reaction tube having no thermocouple is higher than that of the reaction tube (a) having a thermocouple and the reaction yield thereof is lower in contrast.

The multi-tube reactor is usually constituted of several thousands to tens of thousands of reaction tubes, and the number of reaction tubes having a temperature measuring means such as a thermocouple and the like (hereinafter, referred to simply as measuring reaction tube in some cases) among these reaction tubes is only several to tens. Therefore, in a gas-phase catalytic reaction using such a multi-tube reactor, particularly in a gas-phase catalytic oxidation reaction which is an exothermic reaction, its reaction results are dominated by the reaction results of a large majority of reaction tubes having no temperature measuring means (hereinafter, referred to simply as non-measuring reaction tube in some cases). It is estimated that the temperature of a catalyst layer in a large majority of non-measuring reaction tubes is usually higher than the temperature of a catalyst layer measured by a measuring reaction tube having a temperature measuring means. In other words, even if a multi-tube reactor is operated under reaction conditions by which a measuring reaction tube shows specific catalyst layer temperature, the resulting reaction result should approximate the reaction result of a non-measuring reaction tube which is estimated to have an actually higher catalyst layer temperature than this.

In view of the above-mentioned facts, the present inventors have found that even if a measuring reaction tube and a non-measuring reaction tube are immersed in the same heat medium and reactions are conducted under substantially the same condition in a pilot test for setting the conditions for a gas-phase catalytic oxidation reaction by a multi-tube reactor, or even if contrivances described in the above-mentioned patent documents are performed, it is in fact impossible to make reactions in catalyst layers of both reaction tubes the same, and that when rather the catalyst layer temperature or temperature profile of a measuring reaction tube is used as a typical value of the catalyst layer temperature or temperature profile of this reaction and when the reaction condition of a multi-tube reactor is set using the reaction result of a non-measuring reaction tube which is estimated to be an actually higher catalyst temperature than this typical value, particularly the reaction yield, as a typical value of the reaction result of this reaction, correlation between the pilot test result and operation in a multi-tube reactor is higher, leading to completion of the present invention.

Namely, the present invention is a pilot test method of setting the reaction conditions for a gas-phase catalytic reaction using a multi-tube reactor constituted of a great number of reaction tubes having inside a layer of a solid particle-form catalyst, wherein

(1) a plurality of reaction tubes which are substantially the same as the reaction tube of the above-mentioned multi-tube reactor are immersed in a heat medium of which temperature can be controlled, and these reaction tubes are composed of at least one reaction tube having a temperature measuring means provided for measuring the temperature of the catalyst layer, and remaining reaction tubes having no temperature measuring means,

(2) a raw material gas is allowed to flow through the reaction tubes, the temperature of the heat medium is controlled, and the raw material gas is reacted in the catalyst layer in the reaction tube,

(3) the temperature of the catalyst layer is measured in the reactor having a temperature measuring means, and

(4) the reaction result of the reaction product gas to be discharged is analyzed in the reaction tube having no temperature measuring means, and

(5) the reaction conditions are set so that the reaction at the temperature of the catalyst layer measured in (3) generates the reaction result analyzed in (4); and an apparatus thereof.

### BEST MODES FOR CARRYING OUT THE INVENTION

The present invention will be described specifically and in detail below.

The present invention relates to a method for a pilot test for setting reaction conditions in conducting a gas-phase catalytic reaction using a multi-tube reactor, and an apparatus used for this.

According to the method of the present invention, first, a plurality of reaction tubes which are substantially the same as a reaction tube used in a multi-tube reactor used for an actual reaction are prepared. The length and diameter and the like of these reaction tubes are not particularly restricted and may be appropriately determined depending on the use object, and on an industrial scale, the reaction is usually conducted at a reaction tube internal diameter of 15 to 50 mm and a reaction tube length of 200 to 1000 cm. Inside of these reaction tubes, substantially the same solid particle-form catalysts (hereinafter, referred to simply as “catalyst” in some cases) are filled to form catalyst layers respectively, and these reaction tubes are composed of at least one reaction tube having a temperature measuring means and non-measuring reaction tubes. In the measuring reaction tube, a temperature measuring means is buried in the catalyst layer, and for example, temperature measuring means can also be buried so that it is always placed vertically to the axis line direction at the center portion of a reaction tube by providing a vibration preventing means as disclosed in JP-A-2003-1094. By this, an influence by temperature distribution from a peripheral part of a cross-sectional surface vertical to the axis line direction of a reaction tube to the center direction (namely, there is a difference in temperature between the center portion and peripheral portions of the cross-section of a reaction tube since heat exchange is conducted on outer surface portions of the reaction tube by a heat medium) can be removed, and particularly if the temperature measuring means is a temperature measuring means capable of measuring a great number of points movably-inserted along the tube axis direction into a protective tube and when the temperature profile in a catalyst layer in the reaction tube is measured, the measuring part of the temperature measuring means can be always lifted and lowered along the center axis of the reaction tube, therefore, correct temperature distribution along the tube axis direction can be measured, and particularly, the position of a hot spot (point showing maximum temperature) of a catalyst layer can be correctly grasped, preferably.

Here, “substantially the same” reaction tube means a reaction tube of material, form and dimension in the same standard, and the solid particle-form catalyst means a catalyst substance in the form of a solid particle, a solid particle-form substance containing a catalyst substance and an inactive substance, or a mixture of a catalyst substance in the form of solid particle and an inactive substance in the form of a solid particle. Here, “substantially the same” certain substance, for example, solid particle-form catalyst means a substance in the same quality standard, for example, a catalyst substance (or inactive substance) or, a substance prepared under the same condition and method, for example, a solid particle of the same shape formed of a catalyst substance (or inactive substance), alternatively when this substance is a mixture, means a mixture of them of the same composition. The quality standard includes, for example, appearance, component composition, particle size, true specific gravity, bulk specific gravity and falling strength.

“Inactive substance” in this specification means a chemically stable substance not taking part in a reaction in a reaction tube, and for example, in reactions producing (meth)acrolein and (meth)acrylic acid and the like from propylene and isobutylene, any substances may be permissible provided they are stable under the reaction conditions and they have no reactivity with raw material substances such as olefins and the like and products such as unsaturated aldehydes, unsaturated fatty acids and the like. The inactive substance is used for controlling the activity of the whole catalyst in a catalyst filled layer and preventing abnormal heat generation in an exothermic reaction.

The reaction tube used in the method of the present invention is required to be substantially the same as a reaction tube used in a multi-tube reactor which is an actual machine (hereinafter, referred to as “actual machine reaction tube” in some cases). First, a non-measuring reaction tube may be advantageously filled with substantially the same catalyst as that used in an actual machine reaction tube by the same means so as to give substantially the same catalyst layer thickness. Here, “substantially the same catalyst layer thickness” means a catalyst layer thickness within the irregularity in catalyst layer thickness when a plurality of vacant reaction tubes of the same shape are filled with substantially the same catalyst by the same means, and human measurement error in measuring catalyst layer thickness, and specifically, within ±10%, preferably ±4% of the average value of these measured values.

Next, the measuring reaction tube is required to have substantially the same conditions as those of a measuring reaction tube in an actual machine though situations are somewhat complicated as compared with the above-mentioned non-measuring reaction tube. The temperature measuring means includes a thermocouple, resistance thermometer and the like, and usually, a thermocouple is used. Also, the thermocouple includes a one point measuring-mode thermocouple, and a thermocouple capable of measuring a great number of points movably inserted along the tube axis direction into a protective tube, and both thermocouples may be used according to demand, and for measuring the temperature profile of a reaction tube, a thermocouple capable of measuring a great number of points is used.

The method of filling a measuring reaction tube with a catalyst is considered to include the following three methods depending on the condition of the actual reactor. In a first method, a catalyst which is substantially the same as that in a non-measuring reaction tube is filled in substantially the same amount. In this case, when filled by the same method as a non-measuring reaction tube, there is a possibility that the thickness of a catalyst layer in the measuring reaction tube is larger than that of a non-measuring reaction tube by volume equivalent of a temperature measuring means (probably, volume equivalent or more) and differential pressure which is different from that in a non-measuring reaction tube is shown for a gas flow of substantially the same amount.

In a second method, substantially the same catalyst layer thickness as in a non-measuring reaction tube is made, by controlling the amount of a catalyst or by the contrivance in a filling method using substantially the same amount of catalyst as described in JP-A-2003-1094. In this case, there is a possibility that a differential pressure which is different from that for a non-measuring reaction tube is shown for substantially the same amount of gas flow rate. In a third method, substantially the same differential pressure is shown for substantially the same amount of gas flow rate per amount of catalyst, by controlling the amount of a catalyst or by the contrivance in a filling method using substantially the same amount of catalyst as described in JP-A-2003-1094. These filling methods have merits and demerits as described above, and therefore, can be appropriately selected depending on the condition of an actual machine reaction tube having a temperature measuring means.

Here, “substantially the same differential pressure” includes differential pressures which are the same in the range of the error of a pressure gauge measuring its differential pressure and human measurement error occurring depending on measuring method.

In the present invention, when “substantially the same catalyst is filled” in a measuring reaction tube and a non-measuring reaction tube, it is not necessarily required that substantially the same and single catalyst is filled in a measuring reaction tube and a non-measuring reaction tube, and for example, a reaction tube is divided into several blocks along the axis line direction, and catalysts different in particle size, shape and kind are filled in respective blocks, and it may also be permissible that substantially the same catalyst is filled in every block corresponding to a measuring reaction tube and a non-measuring reaction tube. Further, in the present invention, embodiments in which a tube is filled with two or more catalysts different in particle size, shape and kind are not excluded provided that filled in a measuring reaction tube and that filled in a non-measuring reaction tube are substantially the same.

In the present invention, the catalyst may be a combination of two or more catalysts [differing in the kind of catalyst, the kind of inactive substance blended, or the catalyst concentration (compounding ratio of catalyst and inactive substance)], and for example, in a method for producing (meth)acrylic acid and/or (meth)acrolein and the like as effected in a two-stage-reaction, when a reaction of the former stage and a reaction of the latter stage are conducted in a simplex multi-tube reactor, it is also possible, as described above, that a reaction tube is divided into several blocks along the axis line direction and a catalyst for the former stage, inactive substance and a catalyst for the latter stage are filled in this order in every block.

In the catalyst in the present invention, a catalyst substance is used singly, or if necessary, in combination with an inactive substance while changing the catalyst concentration, depending on the use object, and preferable are a catalyst single body and a combination of two or more catalysts selected from those having different catalyst concentrations.

This catalyst constitution (combination) depends on a reaction effected in a multi-tube reactor which is an actual machine. The reaction itself conducted in a multi-tube reactor is not particularly restricted and may be a conventionally-known method, and listed are an all reaction in which temperature change occurs, namely, generation or consumption of heat energy occurs, particularly, reactions of any type in which temperature is important. Particularly suitable are heat generation reactions, of them, oxidation, dehydrogenation, hydrogenation and oxidation dehydrogenation reactions, and examples thereof include oxidation reactions in producing phthalic anhydride from o-xylene, acrolein from propylene, and acrylic acid from propylene and/or acrolein, and in producing methacrylic acid from isobutylene, and the like. This oxidation reaction is a non-uniform catalytic reaction in which a catalyst substance is present in the form of a solid particle. Therefore, the multi-tube reactor is suitable, for example, for conducting a gas-phase catalytic oxidation reaction using a catalyst such as catalyst particles obtained by coating non-supported catalyst particles or a carrier particle with a catalyst substance, and the like.

The catalyst used in the present invention may have a particle structure in which the whole particles are formed of a catalyst substance, and may have a particle structure formed by using a composition obtained by adding and mixing suitable additives such as a binder and the like into a catalyst substance, and the particle structure is not particularly restricted provided it is a particle constituted using a catalyst substance such as a particle structure obtained by supporting (including various embodiments such as fixation, immersion, adhesion, adsorption, bonding, adhesion, connection, coating, filling, impregnation and the like) a catalyst substance on a suitable carrier particle.

The shape of the above-mentioned catalyst constituted using a catalyst substance is also not particularly restricted, and particles of various geometrical shapes can be used in a non-measuring reaction tube and measuring reaction tube, and it may be, for example, any shape such as a sphere, column, Raschig ring, ring, star, indeterminate form and the like, and desirable are those having a catalyst active region as large as possible per unit volume in a gas-phase catalytic reaction of a raw material gas, and particularly preferable is use of a catalyst in the form of ring since it has an effect of preventing heat reserve at a hot spot portion, in exothermic reactions such as an oxidation reaction and the like.

The particle size of a catalyst which can be used in the present invention cannot be univocally restricted since it differs depending on the residence time of a reaction gas in a reaction tube, differential pressure, the internal diameter of a non-measuring reaction tube and measuring reaction tube applied, the structure and shape of a catalyst particle, and the like, and it is usually in the range of 1 to 20 mm, preferably 2 to 15 mm, more preferably 3 to 10 mm. It is preferable that the particle size of a catalyst particle is not lower than the lower limit since disadvantages such as a decrease in the yield of the intended product and excessive increase in differential pressure as a result of an increase in sequential reactions do not occur easily. On the other hand, it is preferable that the particle size of a catalyst particle is not higher than the upper limit since then disadvantages such as a decrease in contact efficiency between a catalyst particle and a reaction gas (reaction medium) cause a decrease in the yield of the intended product, and the like do not occur easily. Regarding the particle size of a catalyst particle, for example, when the catalyst particle is in the form of a sphere or column, it means its diameter, and when in the form of a ring, it means its outer diameter, and when in the form of an ellipse, it means an average value of its major diameter and its minor diameter.

The method of molding a catalyst is not particularly restricted, and suitable molding methods may be appropriately determined depending on the structure, shape and the like of a catalyst as described above, and for example, supported molding, extrusion molding, tabletting molding and the like can be adopted. Further, methods of supporting a suitable catalyst material on a suitable carrier particle, for example, a fire resistant carrier particle and the like, can be used.

The catalyst substance used in the present invention is not particularly restricted and is appropriately determined depending on use object, and conventionally known various catalyst substances can be used.

Regarding a specific example of a catalyst substance, catalyst substances used for production of (meth)acrolein and (meth)acrylic acid by a gas-phase catalytic oxidation reaction of propylene or isobutylene will be described in some detail, however, the scope of the invention is not limited to these.

Usually adopted as this reaction is a method composed of a former stage reaction in which propylene or isobutylene is oxidized in the presence of a molybdenum-bismuth-based complex oxide which is an oxidation catalyst to produce mainly (meth)acrolein, and a latter stage reaction in which (meth)acrolein produced in the former stage reaction is oxidized in the presence of a molybdenum-vanadium-based complex oxide to produce (meth)acrylic acid.

As the catalyst substance used in the former stage reaction of this gas-phase catalytic oxidation reaction, molybdenum-bismuth-based complex oxides of the following formula (1) are listed.
MoₐW_{b}Bi_{c}Fe_{d}AₑD_{f}E_{g}GₕJᵢOₓ (1)

Here, Mo, W, Bi, Fe and O represent an element meant by each symbol; A represents at least one element selected from cobalt and nickel; D represents at least one element selected from sodium, potassium, rubidium, cesium and thallium; E represents at least one element selected from alkaline earth metals; G represents at least one element selected from phosphorus, tellurium, antimony, tin, cerium, lead, niobium, manganese, arsenic, boron and zinc; J represents at least one element selected from silicon, aluminum, titanium and zirconium; a, b, c, d, e, f, g, h, i and x represent the atomic ratio of each element; when a is 12, b is 0 to 10, c is 0 to 10 (preferably, 0.1 to 10), d is 0 to 10 (preferably, 0.1 to 10), e is 0 to 15, f is 0 to 10 (preferably, 0.001 to 10), g is 0 to 10, h is 0 to 4, i is 0 to 30, and x is a numerical value determined depending on the oxidation condition of each element.

As the catalyst substance used in the latter stage reaction of this gas-phase catalytic oxidation reaction, molybdenum-vanadium-based complex oxides of the following general formula (2) are listed.
MoₐV_{b}W_{c}Cu_{d}QₑZ_{f}Oₓ (2)

Here, Mo, V, W, Cu and O represent an element meant by each symbol; Q represents at least one element selected from magnesium, calcium, strontium and barium; Z represents at least one element selected from titanium, zirconium, cesium, chromium, manganese, iron, cobalt, nickel, zinc, niobium, tin, antimony, lead and bismuth; a, b, c, d, e, f and x represent the atomic ratio of each element; when a is 12, b is 2 to 14, c is 0 to 12, d is 0 to 6, e is 0 to 3, f is 0 to 3, and x is a numerical value determined depending on the oxidation condition of each element.

These catalyst substances can be prepared, for example, by a method described in JP-A-63-54942.

In the catalyst used in the present invention, an inactive substance can be used in combination together with a catalyst substance, as described above. The inactive substance may be combined with a catalyst substance and formed into particles in the same shape by the same method as for the above-mentioned catalyst constituted using a catalyst substance, alternatively, an inactive substance may be formed into inactive particles of an appropriate shape, before being combined with particles formed analogously using a catalyst substance.

The inactive substance is not particularly restricted provided it is a stable substance not taking part in a reaction in a reaction tube as described above, and appropriately determined depending on the use object, and conventionally known inactive materials can be used. Specific examples of the inactive substance include fire resistant substances such as alumina, zirconium oxide, titanium oxide, alundum, mullite, carborundum, stainless steal, silicon carbide, steatite, earthenware, porcelain, iron, various ceramics and the like.

The shape of the inactive particle constituted using an inactive substance is not particularly restricted and can be a sphere, column, cylinder, wire gauze, plate and the like, and additionally, those of various shapes are already commercially available as a filling substance, and as those which are substantially the same materials are readily available, there can be utilized, for example, a Raschig ring, interlocks saddle, Berl saddle, ceramic ball, McMahon, Dickson and the like. The particle size of the inactive particle is preferably in the same range as the particle size of the above-mentioned catalyst.

The use amount of the inactive substance is appropriately determined depending on the intended catalytic activity, and for example, it is preferable to adopt a method in which a catalyst filling layer of a reaction tube is partitioned, and the use amount of an inactive substance is increased for suppressing an excessive increase in a catalyst layer temperature due to excess reaction by lowering catalytic activity around a raw material gas inlet, and the use amount of an inactive substance is decreased for suppressing the remainder of a raw material gas by promotion of a reaction by increasing catalytic activity around a reaction gas outlet.

The physical method for filling a reaction tube with a catalyst is not particularly restricted, and can be conducted according to ordinary methods. In this case, it is preferable to fill a reaction tube leaving a space in its upper portion. The reaction tube usually has a catalyst presser at its bottom, and a catalyst is charged from the upper part of the reaction tube.

Here, particularly as the oxidation catalyst used in a gas-phase catalytic oxidation reaction and the like, those obtained by molding a powdery catalyst such as a molybdenum-bismuth-based complex oxide catalyst and the like by an extrusion molding method or tabletting molding method and the like as described later are preferably used, however, when densely molded excessively, the substantial surface area of a catalyst decreases to lower the catalytic activity, resultantly, a catalyst is molded so as to obtain suitable apparent density, namely, so that it does not become too dense and hard. Therefore, the thus molded catalyst is relatively fragile against outer force, and tends to collapse by impact in filling to become a powder. When the amount of the collapsed catalyst increases, there is a problem of an increase in differential pressure of a reaction tube.

As the method of suppressing collapse and pulverization of a catalyst in filling with a catalyst, the following methods are mentioned:

(1) The surface of a catalyst is coated with an organic polymer compound having a depolymerization property, to improve the mechanical strength of a catalyst (Japanese Patent No. 2852712).

(2) When a catalyst is dropped and filled from the upper part of a reaction tube, a substance in the form of a string having shape and volume substantially not obstructing dropping of a catalyst is allowed to intervene in a reaction tube (JP-A-5-31351).

(3) Dry ice is filled in a reaction tube prior to dropping and filling of a catalyst, then, a catalyst is filled, then, dry ice is removed by vaporization (JP-A-10-277381).

(4) A liquid substance is filled in a reaction tube prior to dropping and filling of a catalyst, then, a catalyst is filled, then, the liquid substance is removed (JP-A-9-141084).

(5) An automatic filling machine having a catalyst supplying conveyor of which catalyst filling time can be controlled is used (JP-A-11-333282), and filling of a catalyst in the present invention can be conducted by any of these methods or by a suitable combination of them.

In the method of the present invention, the heat medium into which a plurality of reaction tubes composed of a measuring reaction tube and non-measuring reaction tube are immersed are not necessarily limited, and preferable is use of a nitrates-mixture melted salt (niter) generally used in a gas-phase catalytic reaction in a multi-tube reactor. The heat medium is temperature-controllable by a heat exchange means such as a heat exchanger and the like, and a heating apparatus such as a boiler, electrothermal apparatus and the like. A plurality of reaction tubes composed of a measuring reaction tube and non-measuring reaction tube are kept immersed in a heat medium by being fixed by an appropriate means.

Next, a raw material gas is allowed to flow through a measuring reaction tube and non-measuring reaction tube, and the temperature of a heat medium is controlled, to react the raw material gas in a catalyst layer in a reaction tube. The raw material gas is a raw material gas for a reaction desired to be performed using a multi-tube reactor which is an actual machine, and for example, in a reaction of producing (meth)acrolein and (meth)acrylic acid from propylene or isobutylene, it is a raw material gas containing propylene or isobutylene.

Regarding the method of allowing a raw material gas to flow through a measuring reaction tube and non-measuring reaction tube, preferable is adoption of a method approximating as near as possible the condition in which raw material gases are flowing through a reaction tube having no temperature measuring means and a reaction tube having a temperature measuring means in an actual machine, and for example, there is a method in which raw material gases of substantially the same standard condition volume flow rate are allowed to flow through a measuring reaction tube and non-measuring reaction tube, a method in which raw material gas flow rates in respective tubes are controlled so as to give substantially the same catalyst layer space velocity (SV), a method in which raw material gas flow rates in respective tubes are controlled so that the differential pressures in reaction tubes are substantially identical. In an actual machine, all reaction tubes are usually communicating tubes, namely, a space at the raw material gas introduction side of a reaction tube and a space at the reaction product gas discharging side thereof form the same space, and accordingly, differential pressures applied on reaction tubes are substantially the same. In this case, gas flow rates flowing through every reaction tube, particularly, through a measuring reaction tube and non-measuring reaction tube can be different in some cases.

Here, a fixed bed catalyst layer for which a raw material gas is introduced from the upper part of the catalyst layer is hypothesized, however, the present method can be applied also to the case of a fluidized bed catalyst layer for which a raw material gas is introduced from the lower part of the catalyst layer.

The heat medium is heated up to a temperature at which a raw material gas introduced initiates a reaction by an appropriate means, for example, a heating apparatus such as a boiler, electrothermal apparatus and the like. When the reaction is a gas-phase catalytic oxidation reaction, since a heat medium acts as a refrigerant for absorbing heat generation due to an oxidation reaction, after initiation of the reaction, the heat medium is, if necessary, introduced into an appropriate means such as a heat exchanger and the like and cooled therein. When the reaction reaches a steady state, the temperature of a catalyst layer is measured in a measuring reaction tube, and the reaction result of a reaction product gas discharged, particularly, the yield of the intended substance is analyzed in a non-measuring reaction tube, and because of the above-mentioned reason, the reaction conditions of an actual machine are set so that a reaction at a catalyst layer temperature measured by a measuring reaction tube generates a reaction result analyzed by a non-measuring reaction tube.

Next, production of (meth)acrolein and (meth)acrylic acid by a gas-phase catalytic oxidation reaction of propylene or isobutylene as described above will be described as a typical gas-phase catalytic reaction conducted using a multi-tube reactor according to the present invention.

Typical modes of the above-mentioned gas-phase catalytic oxidation reaction industrialized include a one-pass mode, unreacted propylene (or isobutylene) recycle mode and combusted waste gas recycle mode.

The one-pass mode is a method in which propylene (or isobutylene), air and water vapor are, in a former stage reaction, mixed and supplied through a reaction raw material gas inlet of each reaction tube of a multi-tube reactor for the former stage reaction, and converted mainly into (meth)acrolein and (meth)acrylic acid, and supplied to reaction tubes of a multi-tube reactor for a latter stage reaction without separating the outlet gas from the product, to oxidize (meth)acrolein into (meth)acrylic acid. In this case, it is also common that air and water vapor necessary for reaction in a latter stage reaction are added to the former stage reaction outlet gas and supplied to the latter stage reaction.

The unreacted propylene (or isobutylene) recycle mode is a method in which a reaction product gas containing (meth)acrylic acid obtained at the outlet of a latter stage reaction is introduced into a (meth)acrylic acid collecting apparatus to collect (meth)acrylic acid in the form of aqueous solution, a part of waste gas containing unreacted propylene (or isobutylene) is supplied from the collecting apparatus to the reaction raw material gas inlet of the former stage reaction to recycle a part of unreacted propylene (or isobutylene).

The combusted waste gas recycle mode is a method in which a reaction product gas containing (meth)acrylic acid obtained at the latter stage reactor outlet is introduced into a (meth)acrylic acid collecting apparatus to collect (meth)acrylic acid in the form of an aqueous solution, the waste gas from the collecting apparatus is totally combusted and oxidized to convert unreacted propylene and the like contained into mainly carbon dioxide and water, and a part of the resulting combusted waste gas is supplied to the former stage raw material gas inlet.

In this reaction conducted using a multi-tube reactor, a mixed gas composed, for example, of 4 to 15 vol % of propylene, 4 to 30 vol % of oxygen, 0 to 60 vol % of water vapor, and 20 to 80 vol % of inert gases such as nitrogen, carbon dioxide and the like is introduced into a catalyst layer of 250 to 450° C. under a positive pressure of 50 to 200 kPa (gauge pressure) at a space velocity (SV) of 300 to 5000 hr⁻¹.

### EXAMPLES

The present invention will be illustrated further specifically by examples below.

Preparation of Catalyst

94 parts by weight of ammonium paramolybdate was dissolved with heating into 400 parts by weight of pure water. Separately, 7.2 parts by weight of ferric nitrate, 25 parts by weight of cobalt nitrate and 38 parts by weight of nickel nitrate were dissolved with heating into 60 parts by weight of pure water. These solutions were mixed while stirring sufficiently, to obtain a solution in the form of slurry.

Next, into 40 parts by weight of pure water was dissolved 0.85 parts by weight of borax and 0.36 parts by weight of potassium nitrate under heat, then, to this was added the above-mentioned slurry, and 64 parts by weight of granular silica was added to this and the mixture was stirred. Next, to this slurry was added 58 parts by weight of bismuth carbonate previously blended with 0.8 wt % of magnesium and these were mixed while stirring and heat-dried, then, treated in an air atmosphere at 300° C. for 1 hour, the resulting granular solid was tabletting-molded into a columnar shape having a diameter of 5 mm and a height of 4 mm by a molding machine, then, calcined at 500° C. for 4 hours, to obtain a molybdenum-bismuth-based complex oxide catalyst in the form of solid particle of the following general formula (3):
Mo₁₂Bi₅Ni₃Co₂Fe_{0.4}Na_{0.2}Mg_{0.4}B_{0.2}K_{0.1}Si₂₄Oₓ (3)
(wherein, x is a numerical value determined depending on the oxidation condition of each element)
used in a gas-phase catalytic oxidation reaction of propylene.
Measurement of Thickness of Catalyst Layer

Before filling of a solid particle-form catalyst, a length from the top side of a reaction tube to the catalyst presser surface at the bottom of the reaction tube was measured, then, a catalyst was filled, then, a length from the top side of a reaction tube to the catalyst layer surface was measured, and a difference thereof was used as the thickness of the catalyst layer.

Measurement of Differential Pressure of Reaction Tube

The flow rate of a raw material gas supplied to a multi-tube reactor under standard reaction conditions was divided by the number of reaction tubes to obtain the average flow rate of raw material gases flowing through reaction tubes, and air of the same amount as this average flow rate was allowed to flow through reactions tubes for a specimen and its differential pressure was measured. Namely, since the raw material gas flow rate under standard reaction conditions in an actual machine test using a multi-tube reactor in the following examples was 12300 Nm³/H, the average flow rate of raw material gases flowing through reaction tubes was 1230 NL/H (number of reaction tubes: 10000).

Measurement of Reaction Tube Gas Flow Rate

The same differential pressure as that for a non-measuring reaction tube in the above-mentioned measuring of reaction tube differential pressure was applied on a measuring reaction tube and air was allowed to flow through this, and the amount of air flowing through the measuring reaction tube in this procedure was measured.

Calculation of Conversion of Propylene, Yield of Acrolein and Acrylic Acid

The conversion of propylene and the yield of acrolein and acrylic acid were calculated according to the following formulae.

ti Propylene conversion (%)=(amount (mol) of propylene reacted)/(amount (mol) of propylene supplied)×100
Acrolein yield (%)=(amount (mol) of acrolein produced)/(amount (mol) of propylene supplied)×100
Acrylic acid yield (%)=(amount (mol) of acrylic acid produced)/(amount (mol) of propylene supplied)×100

### Example 1

Fabrication of Non-Measuring Reaction Tube A1

Into a stainless steel tube having an internal diameter of 25.4 mm and a length of 3.5 m having a catalyst presser at the bottom was charged a solid particle-form catalyst having catalytic activity controlled by mixing balls made of silica having a diameter of 5 mm as an inactive substance with a catalyst substance in the form of a solid particle of the above-mentioned general formula (3), in an amount of 350 mL, 340 mL and 790 mL in this order from the reaction raw material gas introduction port of the reaction tube so that the catalytic activity ratio [amount of catalyst substance/(amount of catalyst substance+amount of inactive substance)] was 0.5, 0.7 and 1, respectively, to form a three-layer catalyst layer. The thickness of the whole catalyst layer was 300 cm, and differential pressure applied on this reaction tube A1 was 19 kPa.

Fabrication of Measuring Reaction Tube B1

In the same stainless steel tube as that for the above-mentioned non-measuring reaction tube A1, a thermocouple capable of measuring temperatures at a great number of points having an outer diameter of 4 mm equipped with a vibration preventing member (thermocouple is inserted movably along the tube axis direction into protective tube) was placed, a solid particle-form catalyst having controlled catalytic activity was filled in an amount of 315 mL, 306 mL and 711 mL, in the same manner as the reaction tube A1, to form a catalyst layer having the same length as that of A1. The thickness of the whole catalyst layer was 300 cm, and differential pressure applied on this reaction tube B1 was 20 kPa. When the same differential pressure as the reaction tube A1 was applied and air was allowed to flow, the flow rate was 1170 NL/H.

Test by Pilot Test Apparatus

In a pilot test apparatus, a holding means holding a plurality of reaction tubes is provided in a waist part (shell) of the apparatus, and a heat medium percolates between the reaction tubes. The heat medium is connected to a heatable or coolable temperature controlling means, and reaction tubes immersed in this heat medium are heated or cooled. A plurality of the reaction tubes set introduce a raw material gas, therefore, raw material gas supplying ports at its top portion are connected to raw material gas supplying means, respectively, via a gas flow rate controlling means. The raw material gas supplying means has detachably a plurality of means capable of supplying a raw material gas to respective raw material gas introduction ports of reaction tubes separately, or to introduction ports of some reaction tubes in one portion. The reaction product gas discharging ports of reaction tubes have selective connecting means capable of being connected to reaction product gas analyzing means individually, or in one portion for some ports, and reaction product gases of measuring reaction tubes are independent, and reaction product gases of non-measuring reaction tubes are in one portion, connected to reaction product gas analyzing means, individually. Further, reaction tubes are connected to means for measuring differential pressure applied on each catalyst layer.

On such a pilot test apparatus, the above-mentioned non-measuring reaction tube A1 and measuring reaction tube B1 were set, and a nitrates mixture-melted salt (niter) was used as a heat medium, a raw material gas composed of 9 vol % of propylene, 15 vol % of oxygen, 9 vol % of water vapor and 67 vol % of nitrogen was used and, the flow rate of the reaction tube A1 was set at 1230 NL/H and the flow rate of the reaction tube B1 was set at 1170 NL/H so that differential pressures in both the reaction tubes were substantially the same. The temperature of the heat medium was 330° C., and the maximum peak temperature of a catalyst layer of the reaction tube B1 was 385° C.

This test apparatus was operated continuously for 4320 hours under this condition, then, the operation was stopped. The conversions of propylene and the yields of acrolein and acrylic acid at the initial reaction, and after continuous operation for 4318 hours directly before stop of the operation are as described below.

<At Initial Reaction>

Non-measuring reaction tube A1

Propylene conversion: 98.5 mol %

Total of acrolein yield and acrylic acid yield: 91.7 mol %

Measuring Reaction Tube B1

Propylene conversion: 98 mol %

Total of acrolein yield and acrylic acid yield: 92 mol %

<After 4318 Hours>

Non-measuring reaction tube A1

Propylene conversion: 97.5 mol %

Total of acrolein yield and acrylic acid yield: 90.3 mol %

Measuring Reaction Tube B1

Propylene conversion: 97 mol %

Total of acrolein yield and acrylic acid yield: 90.6 mol %

Actual Machine Test by Multi-Tube Reactor

A reaction shell (internal diameter: 4500 mm) capable of incorporating 10000 reaction tubes was used as a multi-tube reactor, and 9995 non-measuring reaction-tubes A1 and 5 measuring reaction tubes B1 which were the same as those used in the pilot test were incorporated.

The reaction tube is fixed by tube plates provided at the upper portion and lower portion of the reactor shell and placed in the reactor shell while allowing the reaction raw material gas inlet to face upward. Between the upper and lower two tube plates, a hole is made at the center part, and at the hole portion, at least two kinds of disk baffle boards of a disk baffle board to which a reaction tube is not fixed and a disk baffle board which has smaller diameter than that of a reactor shell and forms a gap, when placed at the center of the reactor shell, between the periphery and the inner wall of the reactor shell are provided and they are fixed to reaction tubes respectively, and the heat medium flows while meandering through the hole of the baffle board and the gap between the periphery and the inner wall (aperture of disk baffle board) and stirred.

The raw material gas is introduced through a raw material gas supplying port at the top of the reactor and flows through a catalyst layer of a large number of reaction tubes, and causes a gas-phase catalytic oxidation reaction there, and the reaction product gas collects at the lower portion of the reactor partitioned by the lowest baffle board from the lower portion of the reaction tube, and extracted from a reaction product gas discharging port at the bottom of the reactor.

Separately, the heat medium is introduced through a heat medium introduction port provided on the side wall of the reactor shell which is slightly higher than the tube plate of the lower portion and rises through a group of reaction tubes while meandering by the baffle boards, discharged from the heat medium discharging port, and a part of these is temperature-controlled by a temperature controlling means such as a heat exchanger and the like, then, returned again to the heat medium introduction inlet.

Thermocouples for measuring one point were placed around the inlet and outlet of the heat medium respectively, and the temperature of the heat medium was measured.

Next, a propylene oxidation reaction was conducted using this multi-tube reactor. The same raw material gas as used in the pilot test was used, and this was supplied at a supplying amount of 12300 Nm³/H under a gauge pressure of 130 kPa (kPaG). A nitrates mixture-melted salt (niter) was used as the heat medium, and the temperature at the heat medium inlet was set at 330° C. The temperature profile of the reaction tube was measured by a measuring reaction tube during the reaction. The average value of the maximum peak temperatures of the catalyst layers was 385° C.

Under this condition, the reactor was operated continuously for 4300 hours, then, operation was stopped. The conversions of propylene and the yields of acrolein and acrylic acid at the initial reaction, and after continuous operation for 4300 hours directly before stop of the operation are as described below.

<At Initial Reaction>

Propylene conversion: 98.5 mol %

Total of acrolein yield and acrylic acid yield: 91.8 mol %

<After 4300 Hours>

Propylene conversion: 97.5 mol %

Total of acrolein yield and acrylic acid yield: 90.4 mol %

It was confirmed that the results of the actual machine test using a multi-tube reactor performed while setting the temperature which was the same as that of the measuring reaction tube B1 in the pilot test coincided approximately with the results of the non-measuring reaction tube A1 in the pilot test, both at the initial reaction and after 4300 hours.

### Example 2

Fabrication of Non-Measuring Reaction Tube A2

A three-layer catalyst layer was formed in approximately the same manner as the non-measuring reaction tube A1 in Example 1.

Fabrication of Measuring Reaction Tube B2

A three-layer catalyst layer was formed in approximately the same manner as the measuring reaction tube B1 in Example 1. However, a thermocouple for measuring one point temperature having an outer diameter of 0.6 mm was used instead of the thermocouple capable of measuring temperatures at a great number of points having an outer diameter of 4 mm. Consequently, the flow rates when air was allowed to flow though the reaction tube B2 were approximately the same under the same differential pressure as A2. The thickness of the whole catalyst layer was 300 cm, and differential pressure applied on this reaction tube B2 was 19 kPa in this case.

Test by Pilot Test Apparatus

A test was conducted by a pilot test apparatus in approximately the same manner as in Example 1 except that the non-measuring reaction tube A2 and measuring reaction tube B2 were used instead of the non-measuring reaction tube A1 and measuring reaction tube B1. The reaction tube A2 and reaction tube B2 were set at 1230 NL/H. The temperature of the heat medium was 330° C., and the peak temperature of the reaction tube B2 at the measuring point of the catalyst layer was 397° C.

This test apparatus was operated continuously for 4320 hours under this condition, then, the operation was stopped. The conversions of propylene and the yields of acrolein and acrylic acid at the initial reaction, and after continuous operation for 4315 hours directly before stop of the operation are as described below.

<At Initial Reaction>

Non-Measuring Reaction Tube A2

Propylene conversion: 98.5 mol %

Total of acrolein yield and acrylic acid yield: 91.7 mol %

Measuring Reaction Tube B2

Propylene conversion: 98.5 mol %

Total of acrolein yield and acrylic acid yield: 91.7 mol %

<After 4315 Hours>

Non-Measuring Reaction Tube A2

Propylene conversion: 97.5 mol %

Total of acrolein yield and acrylic acid yield: 90.3 mol %

Measuring Reaction Tube B2

Propylene conversion: 97.5 mol %

Total of acrolein yield and acrylic acid yield: 90.3 mol %

Actual Machine Test by Multi-Tube Reactor

An actual machine test by a multi-tube reactor was conducted in approximately the same manner as in Example 1 except that 9998 non-measuring reaction tubes A2 and 2 measuring reaction tubes B2 were used instead of 9995 non-measuring reaction tubes A1 and 5 measuring reaction tubes B1. The raw material gas was supplied at a supplying amount of 12300 Nm³/H under a gauge pressure of 130 kPa (kPaG). The temperature at the heat medium inlet was set at 330° C. The average value of the maximum peak temperatures of the catalyst layers was 396° C.

Under this condition, the reactor was operated continuously for 4300 hours, then, operation was stopped. The conversions of propylene and the yields of acrolein and acrylic acid at the initial reaction, and after continuous operation for 4300 hours directly before stop of the operation are as described below.

<At Initial Reaction>

Propylene conversion: 98.5 mol %

Total of acrolein yield and acrylic acid yield: 91.8 mol %

<After 4300 Hours>

Propylene conversion: 97.5 mol %

Total of acrolein yield and acrylic acid yield: 90.4 mol %

It was confirmed that the results of the actual machine test using a multi-tube reactor performed while setting the temperature which was the same as that of the measuring reaction tube B2 in the pilot test coincided approximately with the results of the non-measuring reaction tube A2 in the pilot test, both at the initial reaction and after 4300 hours.

While the invention has been described in detail and with reference to specific embodiments thereof, it will be apparent to one skilled in the art that various changes and modifications can be made therein without departing from the spirit and scope thereof.

This application is based on the Japanese patent application filed on May 13, 2004 (Patent Application No. 2004-143307), the entire contents thereof being hereby incorporated by reference.

### INDUSTRIAL APPLICABILITY

A correlation between the result of a pilot test and operation in a multi-tube reactor can be enhanced by conducting a pilot test according to the method of the present invention, using the catalyst layer temperature or a temperature profile of a reaction tube having an inserted thermocouple as a typical value of the catalyst layer temperature or temperature profile of this reaction, and setting the reaction condition for a multi-tube reactor using the reaction result of a reaction tube having no thermocouple, particularly the reaction yield as a typical value of the reaction result of this reaction.

Therefore, the quality and/or yield of a product can be enhanced by conducting actual industrial production using this pilot test method.

1. A pilot test method for setting the reaction conditions for a gas-phase catalytic reaction using a multi-tube reactor constituted of a great number of reaction tubes having inside a layer of a solid particle-form catalyst, wherein
(1) a plurality of reaction tubes which are substantially the same as the reaction tube of said multi-tube reactor are immersed in a heat medium of which temperature can be controlled, and these reaction tubes are composed of at least one reaction tube having a temperature measuring means provided for measuring the temperature of the catalyst layer, and remaining reaction tubes having no temperature measuring means,
(2) a raw material gas is allowed to flow through the reaction tubes, the temperature of the heat medium is controlled, and the raw material gas is reacted in the catalyst layer in the reaction tube,
(3) the temperature of the catalyst layer is measured in the reaction tube having a temperature measuring means, and
(4) the reaction result of the reaction product gas to be discharged is analyzed in the reaction tube having no temperature measuring means, and
(5) the reaction conditions are set so that the reaction at the temperature of the catalyst layer measured in (3) generates the reaction result analyzed in (4).

2. The pilot test method according to claim 1, wherein said catalyst is an oxidation catalyst containing a molybdenum-bismuth-based complex oxide catalyst or a molybdenum-vanadium-based complex oxide catalyst.

3. The pilot test method according to claim 1, wherein both the reaction tube having a temperature measuring means and the reaction tube having no temperature measuring means have substantially the same thickness of the catalyst layer.

4. The pilot test method according to claim 1, wherein raw material gases having substantially the same catalyst layer space velocity are allowed to flow through both the reaction tube having a temperature measuring means and the reaction tube having no temperature measuring means.

5. The pilot test method according to claim 1, wherein the reaction result is the yield of the reaction intended substance.

6. A gas-phase oxidation method for propane, propylene or isobutylene using a multi-tube reactor, wherein the reactor is operated according to reaction conditions set based on the method according to any of claims 1 to 5.

7. A pilot test apparatus for setting the reaction conditions for a gas-phase catalytic reaction using a multi-tube reactor constituted of a great number of reaction tubes having inside a layer of a solid particle-form catalyst, wherein
(1) a plurality of reaction tubes which are substantially the same as the reaction tube used in said multi-tube reactor are immersed in a common heat medium, and the reaction tubes are composed of at least one tube having a temperature measuring means provided for measuring the temperature of the catalyst layer and remaining tubes having no temperature measuring means, and the heat medium is connected to a heatable or coolable temperature controlling means,
(2) these reaction tubes have a raw material gas supplying port provided at its summit which is connected to a raw material gas supplying means via a gas flow rate controlling means,
(3) a reaction product gas discharging port at the bottom of the reaction tube having a temperature measuring means and a reaction product gas discharging port at the bottom of the reaction tube having no temperature measuring means are connected to separate reaction product gas analyzing means, respectively, and
(4) each reaction tube has a means for measuring differential pressure applied on each catalyst layer.

8. The pilot test apparatus according to claim 7, wherein said catalyst is an oxidation catalyst containing a molybdenum-bismuth-based complex oxide catalyst or a molybdenum-vanadium-based complex oxide catalyst.

9. The pilot test apparatus according to claim 7, wherein the temperature controlling means is a heat exchanger and/or heating apparatus.
